(19) United States
(12) Patent Application Publication
(10) Pub. No.: US 2013/0320589 A1
(43) Pub. Date: Dec. 5, 2013

(54) IMPRINT APPARATUS AND METHOD OF MANUFACTURING ARTICLE

(71) Applicant: Canon Kabushiki Kaisha, Tokyo (JP)

(72) Inventor: Yuichi Fujita, Utsunomiya-shi (JP)

(21) Appl. No.: 13/907,095

(22) Filed: May 31, 2013

(30) Foreign Application Priority Data
Jun. 1, 2012 (JP) 2012-126543

(51) Int. Cl. B29C 59/02

(52) U.S. Cl. CPC B29C 59/026
USPC 264/293; 425/385

(57) ABSTRACT

An imprint apparatus which brings a mold into contact with a resin coated on a substrate, and cures the resin, includes a substrate stage including a substrate chuck which holds the substrate, and a gas flow forming section arranged on the substrate stage so as to form a gas flow on the substrate. The gas flow forming section includes a blower which blows a gas in a direction which intersects with a plane parallel to an upper surface of the substrate, and a changing section which changes a direction, in which the gas blown by the blower flows, so that the gas flows along the upper surface of the substrate. The changing section has a maximum height higher than a height of the upper surface of the substrate held by the substrate chuck.

### BACKGROUND OF THE INVENTION

1. Field of the Invention

The present invention relates to an imprint apparatus and a method of manufacturing an article.

2. Description of the Related Art

The imprint technique is advantageous in forming a nanoscale fine pattern, and is coming into practical use as one of lithography techniques for volume production of magnetic storage media and next-generation semiconductor devices. An imprint apparatus brings a mold (original) into contact with a resin coated on a substrate, and cures the resin in this state to transfer a pattern formed on the mold onto the substrate. In the imprint apparatus, if a particle has adhered to a pattern forming region (shot region) on the substrate, a defect may occur in the pattern to be transferred onto the substrate, or the mold may suffer damage. It is therefore important to prevent particles from adhering to the substrate.

Note that exposure apparatuses having an arrangement which blows a gas onto a substrate are described in Japanese Patent Laid-Open Nos. 2008-91767 and 2009-141190, although their relevancy to the present invention is not so high.

An imprint apparatus brings a mold into contact with a resin coated on a substrate to transfer the pattern of the mold onto the substrate. Also, the mold may be frequently replaced in accordance with an article to be manufactured. It is therefore difficult to arrange, around a mold chuck, a structure for preventing adhesion of particles to the substrate. In addition, when a structure for preventing adhesion of particles to the substrate is arranged on the side of a substrate stage, this must be done so as not to hinder an operation of bringing the mold into contact with the resin.

### SUMMARY OF THE INVENTION

The present invention provides a technique advantageous in terms of suppressing adhesion of particles to a substrate.

One of the aspects of the invention provides an imprint apparatus which brings a mold into contact with a resin coated on a substrate, and cures the resin, comprising: a substrate stage including a substrate chuck which holds the substrate; and a gas flow forming section arranged on the substrate stage so as to form a gas flow on the substrate, wherein the gas flow forming section includes a blower which blows a gas in a direction which intersects with a plane parallel to an upper surface of the substrate, and a changing section which changes a direction, in which the gas blown by the blower flows, so that the gas flows along the upper surface of the substrate, and wherein the changing section has a maximum height higher than a height of the upper surface of the substrate held by the substrate chuck.

Further features of the present invention will become apparent from the following description of exemplary embodiments with reference to the attached drawings.

### BRIEF DESCRIPTION OF THE DRAWINGS

FIG. 1 is a view showing an imprint apparatus according to the first embodiment;

FIG. 2 is a view showing the imprint apparatus according to the first embodiment;

FIG. 3 is a view showing the imprint apparatus according to the first embodiment;

FIG. 4 is a view showing an imprint apparatus according to the second embodiment; and

FIG. 5 is a view showing an imprint apparatus according to the third embodiment.

### DESCRIPTION OF THE EMBODIMENTS

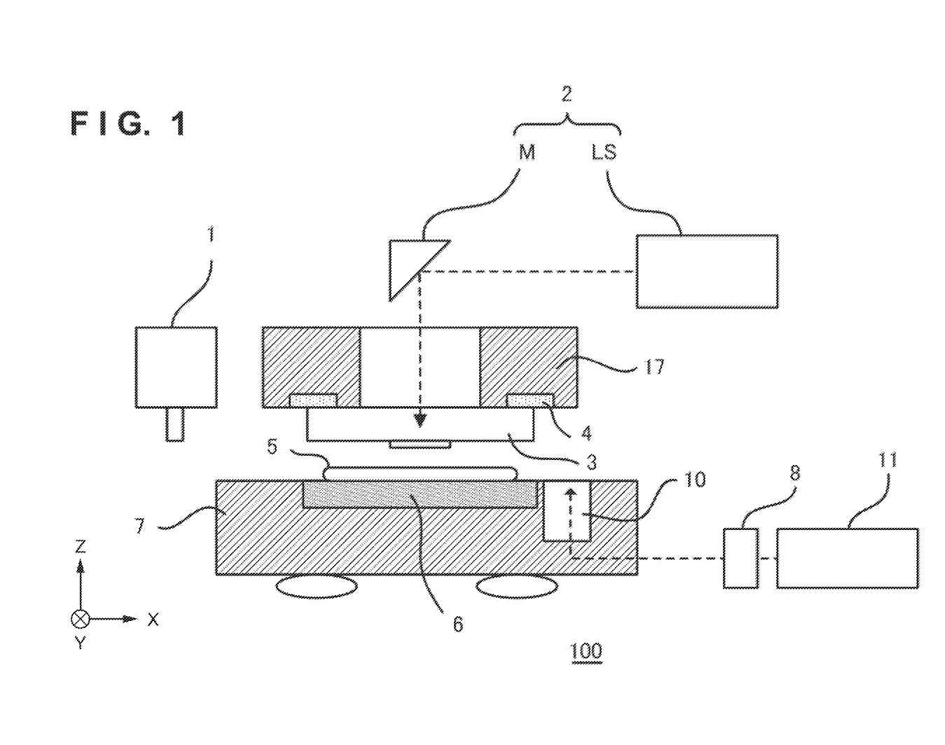

An imprint apparatus 100 according to the first embodiment of the present invention will be described with reference to FIG. 1. The imprint apparatus 100 can include, for example, a substrate stage 7, imprint head 17, curing unit 2, coating unit 1, and gas flow forming section 10. The imprint apparatus 100 brings a mold 3 into contact with a resin coated on a substrate 5 by the coating unit 1, and cures the resin in this state using the curing unit 2 to transfer the pattern of the mold 3 onto the substrate 5. This operation will be referred to as an imprint operation hereinafter.

The substrate stage 7 has a substrate chuck 6 which holds the substrate 5. The substrate stage 7 is driven within at least the X-Y plane by a stage driving mechanism (not shown). The stage driving mechanism is typically configured to drive the substrate stage 7 with respect to six axes (the X-, Y-, and Z-axes and rotations about the X-, Y-, and Z-axes). The substrate 5 is held by the substrate chuck 6 so that its surface is parallel to the X-Y plane. The position and orientation of the substrate stage 7 can be measured by a measuring device such as a laser interferometer, an encoder, a capacitance sensor, an optical sensor, or a laser displacement gauge.

The imprint head 17 has a mold chuck 4 which holds the mold 3. The coating unit 1 coats a resin on the substrate 5. The coating unit 1 can include, for example, a plurality of linearly aligned nozzles. A shot region (imprint target region) can be coated with a resin by moving the substrate stage 7 while discharging the resin from the plurality of nozzles.

The resin can be an ultraviolet-curing resin which cures with ultraviolet rays. In this case, the curing unit 2 is configured to irradiate the resin with ultraviolet rays, and can include, for example, a light source LS which emits ultraviolet rays, and an optical system M for guiding the ultraviolet rays from the light source LS to the resin. Instead, the resin can be a heat-curing resin which cures by heating. In this case, the curing unit 2 is configured to heat the resin.

To bring the mold 3 into contact with the resin coated on the substrate 5 or separate the mold 3 from this resin, the distance between the substrate 5 and the mold 3 is changed. The distance between the substrate 5 and the mold 3 can be changed by, for example, moving at least one of the imprint head 17 and the substrate stage 7 along the Z-axis. The distance between the substrate 5 and the mold 3 can be changed typically by driving the mold chuck 4 or imprint head 17 along the Z-axis. A mechanism for driving the mold chuck 4 can be built into, for example, the imprint head 17.

The mold 3 can also be called a mold or an original. The mold 3 has, for example, a rectangular shape, a protrusive portion at the center of a surface opposed to the substrate 5, and a three-dimensional pattern (for example, a circuit pattern) formed in the protrusive portion. The mold 3 can be formed by, for example, quartz. The mold chuck 4 holds the mold 3 by, for example, vacuum suction or electrostatic attraction. The imprint head 17 can include an internal microscope for observing the positional relationship between an alignment mark formed on the mold 3, and that formed on the substrate 5.

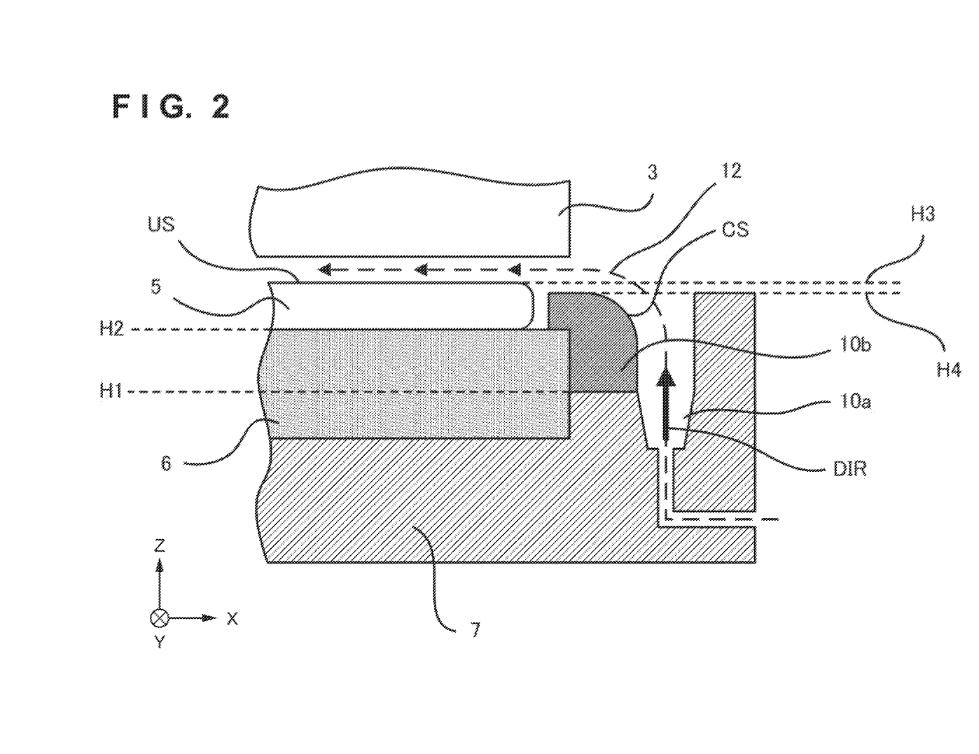

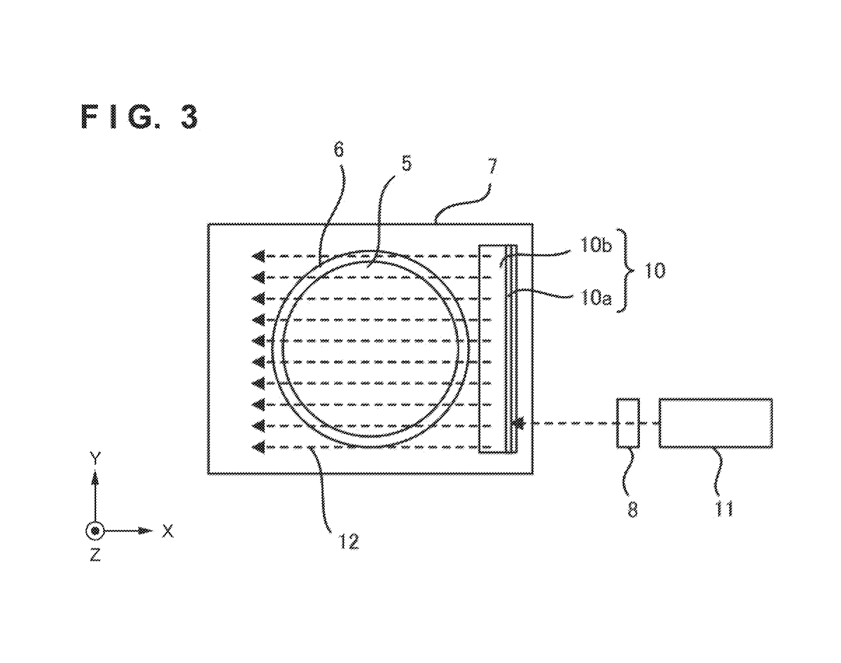

FIG. 2 is a partial enlarged view of the imprint apparatus 100 shown in FIG. 1. FIG. 3 is a view showing the substrate stage 7 of the imprint apparatus 100, shown in FIG. 1, as viewed from above. The gas flow forming section 10 will be described with reference to FIGS. 1, 2, and 3. The gas flow forming section 10 is arranged in the substrate stage 7 to form a gas flow on the substrate 5. The gas flow forming section 10 can include a blower 10a and changing section 10b. The blower 10a blows a gas in a direction DIR which intersects with a plane (a plane parallel to the X-Y plane) parallel to an upper surface US of the substrate 5. The changing section 10b changes the direction, in which a gas blown by the blower 10a flows, so that the gas flows along the upper surface US of the substrate 5. The gas flow formed along the upper surface US of the substrate 5 by the gas flow forming section 10 is effective in terms of suppressing adhesion of particles to the substrate 5.

A maximum height H4 of the changing section 10b is lower than a height H3 of the upper surface of the substrate 5 held by the substrate chuck 6. Such an arrangement is advantageous in terms of preventing interference between the gas flow forming section 10 and the structure (for example, the mold 3) on the side of the imprint head 17. More specifically, such an arrangement obviates the need to widen the interval between the mold 3 and the substrate stage 7 in moving the substrate stage 7 so that the gas flow forming section 10 passes below the mold 3. A height H1 of the top of the blower 10a is preferably lower than the height H3 of the upper surface US of the substrate 5 held by the substrate chuck 6, and more preferably lower than a height H2 of the chuck surface of the substrate chuck 6.

The changing section 10b includes a portion arranged between the substrate chuck 6 and the blower 10a, and the portion can have a curved surface CS which changes the gas flow using the Coanda effect. The radius of curvature of the curved surface CS can be, for example, 1 cm (inclusive) to 20 cm (inclusive). This radius of curvature is preferably 1 cm (inclusive) to 5 cm (inclusive). Note that the Coanda effect is relatively small when the radius of curvature of the curved surface CS is smaller than 1 cm, while the thickness of the substrate stage 7 on which the gas flow forming section 10 is mounted must be set relatively large when the radius of curvature of the curved surface CS is larger than 5 cm. Although the curved surface CS can constitute part of, for example, a cylindrical surface, its shape can be arbitrarily defined as long as the Coanda effect can be obtained. A gas 12 blown by the blower 10a spreads along the curved surface CS. When this occurs, the direction DIR of the gas 12 changes along the upper surface US of the substrate 5.

The gas flow forming section 10 can include a gas supply section 11. The gas supply section 11 can control at least one of the flow rate of a gas supplied to the blower 10a, the timing to supply a gas to the blower 10a, and the type of gas supplied to the blower 10a. The gas flow forming section 10 can also include a filter 8 which filters out particles from a gas supplied to the blower 10a or that blown by the blower 10a.

The gas blown by the blower 10a may be air (clean air from which particles are removed), but may also be a gas (for example, helium, nitrogen, or carbon dioxide) which diffuses (dissolves) into the resin at a rate higher than that of air. Using a gas (to be referred to as an imprint gas hereinafter) which diffuses (dissolves) into the resin at a rate higher than that of air, the time for an imprint operation can be shortened, thus improving the throughput. More specifically, the use of an imprint gas allows the gas in the recessed portion which forms the pattern of the mold 3 to rapidly diffuse into the resin when the mold 3 is brought into contact with the resin, thus shortening the time until air bubbles produced by the gas disappear.

The gas supply section 11 may have a function of switching the gas supplied to the blower 10a. The gas supply section 11 can be configured to, for example, supply an imprint gas to the blower 10a in a first period including the period in which the mold 3 is brought into contact with a resin, and the resin is cured, and supply air to the blower 10a in a second period different from the first period. In this case, an imprint gas is blown by the blower 10a to cover the substrate 5 (and resin) in the first period, and air is blown by the blower 10a to cover the substrate 5 (and resin) in the second period. This makes it possible to suppress adhesion of particles to the substrate 5 while reducing the amount of an imprint gas used.

Although the gas flow forming section 10 preferably forms a gas flow to cover the entire substrate 5, it may form a gas flow to cover a partial region of the substrate 5. The possibility that particles will adhere to the substrate 5 is lower in the latter case as well than in the case wherein no gas flow forming section 10 is provided. When the gas flow forming section 10 forms a gas flow to cover only a partial region of the substrate 5, the partial region preferably includes a shot region (imprint target region). Also, in this case, the time for an imprint operation can be shortened using an imprint gas as a gas which covers only the partial region.

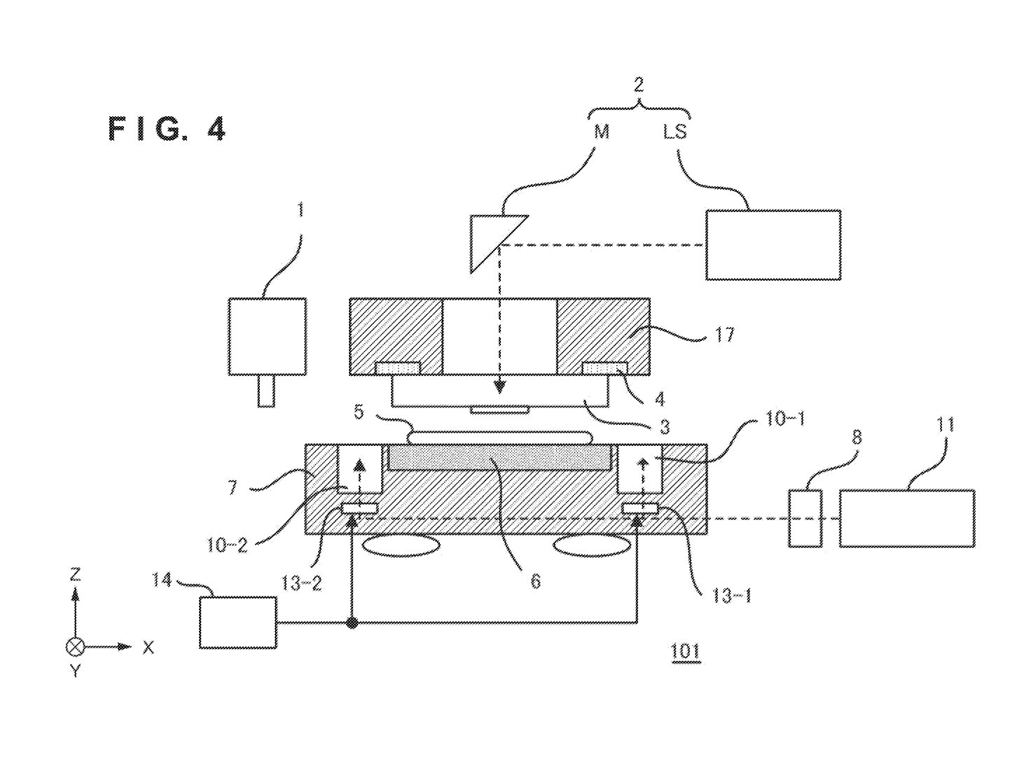

An imprint apparatus 101 according to the second embodiment of the present invention will be described below with reference to FIG. 4. Note that details which are not particularly referred to in the second embodiment can be the same as in the first embodiment. The imprint apparatus 101 according to the second embodiment includes a plurality of gas flow forming sections 10. In an example shown in FIG. 4, the imprint apparatus 101 includes a first gas flow forming section 10-1 and second gas flow forming section 10-2 as the plurality of gas flow forming sections 10. The imprint apparatus 101 can include control valves 13-1 and 13-2 which control supply of a gas to the first gas flow forming section 10-1 and second gas flow forming section 10-2, respectively, and a controller 14 which controls the control valves 13-1 and 13-2.

The first gas flow forming section 10-1 and second gas flow forming section 10-2 can be arranged to allow a substrate chuck 6 to hold a substrate 5 between them.

The controller 14 can determine a gas flow forming section to be used, of the first gas flow forming section 10-1 and second gas flow forming section 10-2, in accordance with the moving direction of a substrate stage 7. When, for example, the substrate stage 7 moves in the +X-direction, the controller 14 can select the first gas flow forming section 10-1 as a gas flow forming section to be used so as to form a gas flow in a direction opposite to the moving direction. Similarly, when the substrate stage 7 moves in the −X-direction, the controller 14 can select the second gas flow forming section 10-2 as a gas flow forming section to be used so as to form a gas flow in a direction opposite to the moving direction. In contrast to the above case, when, for example, the substrate stage 7 moves in the +X-direction, the controller 14 can select the second gas flow forming section 10-2 as a gas flow forming section to be used so as to form a gas flow in a direction identical to the moving direction. Similarly, when the substrate stage 7 moves in the −X-direction, the controller 14 can select the first gas flow forming section 10-1 as a gas flow forming section to be used so as to form a gas flow in a direction identical to the moving direction.

Alternatively, the controller 14 can use both the first gas flow forming section 10-1 and second gas flow forming section 10-2 when the substrate stage 7 moves before a resin is coated on the substrate 5 by a coating unit 1 and cures. In this case, the resin on the substrate 5 can be prevented from moving relative to the substrate 5 (by the action of inertia) with movement of the substrate stage 7.

The imprint apparatus 101 may include three or more gas flow forming sections 10, and the controller 14 can determine a gas flow forming section to be used, of a plurality of gas flow forming sections, in accordance with the moving direction of the substrate stage 7.

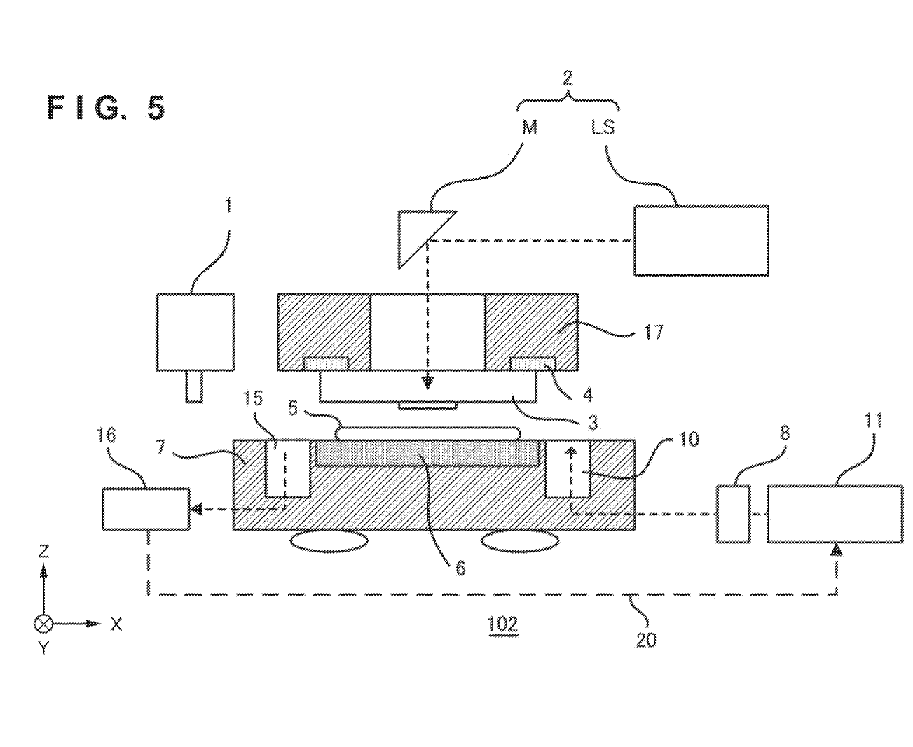

An imprint apparatus 102 according to the third embodiment of the present invention will be described below with reference to FIG. 5. Note that details which are not particularly referred to in the third embodiment can be the same as in the first or second embodiment. The imprint apparatus 102 according to the third embodiment includes a recovering section 16 which recovers a gas which is blown by the blower of a gas flow forming section 10 and passes on a substrate 5. The recovering section 16 can recover a gas through, for example, a recovering port 15 arranged on a substrate stage 7. Providing the recovering section 16 makes it possible to prevent or suppress, for example, a drift, in the optical path of a measuring device, of a gas which is blown by the blower of the gas flow forming section 10 and passes on the substrate 5. The optical path of a measuring device means, for example, the optical path of a measuring device for measuring the position of the substrate stage 7. If the types and/or temperatures of a gas blown by the blower of the gas flow forming section 10 and the ambient gas are different, the refractive index in the optical path of the measuring device may fluctuate, leading to degradation in accuracy of the measuring device. Therefore, the accuracy of measurement by the measuring device can be improved by providing the recovering section 16.

The imprint apparatus 102 may also include a path 20 configured to return the gas recovered by the recovering section 16 to the blower of the gas flow forming section 10. In an example shown in FIG. 5, the gas recovered by the recovering section 16 is returned to the blower of the gas flow forming section 10 via the path 20 and a gas supply section 11.

### Application Example

A method of manufacturing an article using the above-mentioned imprint apparatus will be described below. This manufacturing method includes a step of forming the pattern of a resin on a substrate using the above-mentioned imprint apparatus, and a step of processing (for example, etching) the substrate having the pattern formed on it. The article can be a device such as a semiconductor device, a liquid crystal display device, or a micromachine.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-126543, filed Jun. 1, 2012, which is hereby incorporated by reference herein in its entirety.

What is claimed is:

1. An imprint apparatus which brings a mold into contact with a resin coated on a substrate, and cures the resin, comprising:
a substrate stage including a substrate chuck which holds the substrate; and
a gas flow forming section arranged on the substrate stage so as to form a gas flow on the substrate,
wherein the gas flow forming section includes a blower which blows a gas in a direction which intersects with a plane parallel to an upper surface of the substrate, and a changing section which changes a direction, in which the gas blown by the blower flows, so that the gas flows along the upper surface of the substrate, and
wherein the changing section has a maximum height higher than a height of the upper surface of the substrate held by the substrate chuck.

2. The apparatus according to claim 1, wherein the changing section includes a portion arranged between the substrate chuck and the blower, and the portion has a curved surface which changes the gas flow using the Coanda effect.

3. The apparatus according to claim 2, wherein a radius of curvature of the curved surface is not less than 1 cm and is not greater than 20 cm.

4. The apparatus according to claim 1, wherein a height of a top of the blower is lower than a height of a chuck surface of the substrate chuck.

5. The apparatus according to claim 1, wherein
the gas flow forming section constitutes a first gas flow forming section, the imprint apparatus further comprising a second gas flow forming section arranged on the substrate stage so as to form a gas flow on the substrate, and
the first gas flow forming section and the second gas flow forming section are arranged to allow the substrate chuck to hold the substrate therebetween.

6. The apparatus according to claim 5, wherein, of the first gas flow forming section and the second gas flow forming section, a gas flow forming section to be used is determined in accordance with a moving direction of the substrate stage.

7. The apparatus according to claim 5, wherein both the first gas flow forming section and the second gas flow forming section are used when the substrate stage moves before the resin is coated on the substrate and cures.

8. The apparatus according to claim 1, wherein
the gas flow forming section includes a plurality of gas flow forming sections, and
of the plurality of gas flow forming sections, a gas flow forming section to be used is determined in accordance with a moving direction of the substrate stage.

9. The apparatus according to claim 1, further comprising a recovering section which recovers the gas that is blown by the blower and passes on the substrate.

10. The apparatus according to claim 9, further comprising a path configured to return the gas recovered by the recovering section to the blower.

11. The apparatus according to claim 1, wherein a gas which diffuses into the resin at a rate higher than a diffusion rate of air is blown by the blower in a first period including a period in which the mold is brought into contact with the resin and the resin is cured, and air is blown by the blower in a second period different form the first period.

12. A method of manufacturing an article, comprising:
forming a resin pattern on a substrate using an imprint apparatus which is configured to bring a mold into contact with a resin coated on the substrate, and cures the resin to form the resin pattern; and
processing the substrate having the pattern formed thereon,
wherein the imprint apparatus comprises:
a substrate stage including a substrate chuck which holds the substrate; and
a gas flow forming section arranged on the substrate stage so as to form a gas flow on the substrate,
wherein the gas flow forming section includes a blower which blows a gas in a direction which intersects with a plane parallel to an upper surface of the substrate, and a changing section which changes a direction, in which the gas blown by the blower flows, so that the gas flows along the upper surface of the substrate, and
wherein the changing section has a maximum height higher than a height of the upper surface of the substrate held by the substrate chuck.
